(19) United States
(12) Patent Application Publication
(10) Pub. No.: US 2025/0048505 A1
(43) Pub. Date: Feb. 6, 2025

(54) DOMESTIC APPLIANCE DEVICE

(71) Applicant: BSH Hausgeräte GmbH, Munich (DE)

(72) Inventors: Rafael Alonso Esteban, Huesca (ES); Jose Maria Garcia del Pozo, Zaragoza (ES); Eduardo Imaz Martinez, Tudela (Navarra) (ES); Javier Lasobras Bernad, EJEA DE LOS CABALLEROS (ZARAGOZA) (ES); Sergio Llorente Gil, Zaragoza (ES); Maria Parra Borderías, Zaragoza (ES); Julio Rivera Peman, Cuarte de Huerva (Zaragoza) (ES)

(21) Appl. No.: 18/684,713

(22) PCT Filed: Aug. 29, 2022
(86) PCT No.: PCT/EP2022/073933

§ 371 Date: Feb. 19, 2024

(30) Foreign Application Priority Data
Sep. 16, 2021 (EP) 21382838.7

(51) Int. Cl. H05B 6/06; G01J 5/00; G01J 5/30; H05B 6/12

(52) U.S. Cl. CPC H05B 6/062; G01J 5/0003; G01J 5/30; H05B 6/1209; H05B 2213/07

(57) ABSTRACT

A household appliance apparatus, in particular a cooktop apparatus, includes a temperature sensor unit which includes a photodiode designed to detect incident infrared radiation and to convert the incident infrared radiation into a measurement signal. The measurement signal is amplified by an amplifier of an amplifier unit. A compensation unit at least partially compensates for a temperature influence as the infrared radiation is converted into the measurement signal and/or the measurement signal is amplified.

The invention relates to a household appliance apparatus as claimed in the preamble of claim 1, a household appliance as claimed in claim 14 and a method for operating a household appliance apparatus as claimed in the preamble of claim 15.

Cooktops which have infrared sensors for measuring the temperature of items of cookware are already known from the prior art. An infrared sensor which converts incident infrared radiation into a photocurrent can be implemented in a cooktop, for example, by means of a photodiode. Since photocurrents have very low current strengths, these measurement signals have to be amplified for further evaluation and temperature determination. Conventional operational amplifiers, in particular transimpedance amplifiers, are used to this end. Previously there has been the drawback, however, that temperature measurements by means of photodiodes are more prone to error as the temperature rises. This is because, in addition to the actual photocurrent, photodiodes always generate a so-called dark current which is added to the photocurrent, the value thereof increasing exponentially as the temperature rises. Thus sufficiently accurate temperature measurements are no longer possible from an ambient temperature of above approximately 75° C. For this reason, in the previously known cooktops, photodiodes cannot be positioned directly in a cooking region but have to be arranged in cooler regions below or adjacent to the cooktop plate, wherein the infrared radiation to be detected has to be conducted from the cooking region into the cooler region. Optical fibers are used to this end, for example. Such solutions, however, are complex and expensive in terms of production. Moreover, in addition to measuring errors which are caused by the dark current of the photodiode, which also occurs in the cooler ambient temperatures of the photodiode, albeit to a lesser extent, the components of the operational amplifier are also subject to temperature-related influences and thus cause additional measuring errors. These temperature influences are cumulative and lead to a so-called offset voltage at the output of the operational amplifier, whereby in previously known cooktops a desired accuracy in temperature measurements by means of photodiodes cannot be achieved or only with a very high level of technical effort.

The object of the invention consists, in particular but is not limited thereto, in providing a generic apparatus having improved properties regarding measuring accuracy. The object is achieved according to the invention by the features of claims 1 and 14, while advantageous embodiments and developments of the invention can be derived from the dependent claims.

The invention is based on a cooktop apparatus, in particular an induction cooktop apparatus, having at least one temperature sensor unit which has at least one photodiode provided for the purpose of detecting incident infrared radiation and converting it into a measurement signal, and having at least one amplifier unit which has at least one amplifier for amplifying the measurement signal.

It is proposed that the household appliance apparatus has a compensation unit for at least partially compensating for temperature influences on the conversion and/or amplification of the measurement signal.

Advantageously, a household appliance apparatus having improved properties regarding a measuring accuracy can be provided by means of such an embodiment. Advantageously, temperature-related interference in the conversion and/or amplification of the measurement signal can be reduced, preferably minimized, whereby a measuring accuracy can be significantly increased. In addition, advantageously the production can be simplified, for example by the photodiode being arranged directly in a high temperature region, and thus it is possible to dispense with the previously required radiation-conducting elements, such as optical fibers, for transporting the infrared radiation to the photodiode. As a result, advantageously a cost saving can also be achieved, with at the same time a greater measuring accuracy.

A “cooktop apparatus”, in particular an “induction cooktop apparatus”, is intended to be understood to mean at least one part, in particular a subassembly, of a cooktop, in particular an induction cooktop, wherein in addition accessories for the cooktop can be also encompassed thereby, such as for example a sensor unit for the external measurement of a temperature of an item of cookware and/or a food to be cooked. In particular, the cooktop apparatus, in particular the induction cooktop apparatus, can also comprise the entire cooktop, in particular the entire induction cooktop.

A “household appliance apparatus”, in particular a “cooking appliance apparatus”, advantageously a “cooktop apparatus” and particularly advantageously an “induction cooktop apparatus”, is intended to be understood to mean, in particular, at least one part, in particular a subassembly, of a household appliance, in particular a cooking appliance, advantageously a cooktop and particularly advantageously an induction cooktop. For example, a household appliance having the household appliance apparatus could be a dishwasher and/or a washing machine and/or a dryer. Advantageously, a household appliance having the household appliance apparatus is a cooking appliance. A household appliance which is configured as a cooking appliance could be, for example, an oven and/or a microwave and/or a grill appliance and/or a steam cooking appliance. Advantageously, a household appliance configured as a cooking appliance is a cooktop and preferably an induction cooktop.

Preferably, the household appliance apparatus has a cooktop plate for setting down an item of cookware. Alternatively, it is also conceivable that the cooktop plate is part of the household appliance which comprises the household appliance apparatus and which is configured as a cooktop.

Preferably, the household appliance apparatus has a control unit. The control unit is provided to control and/or to regulate the temperature sensor unit and/or the amplifier unit and/or the compensation unit and/or further units, in particular the heating unit. The control unit has at least one computing unit which is preferably configured as a microprocessor. In addition to the computing unit, the control unit has a memory unit with at least one program which is stored therein and which is provided to be executed by the computing unit.

The temperature sensor unit is provided for detecting infrared radiation and converting the detected infrared radiation into at least one measurement signal which characterizes at least one temperature parameter of at least one item of cookware and/or the cooktop plate. The temperature parameter could comprise and/or characterize, for example, at least one temperature of the item of cookware and/or the cooktop plate. The temperature sensor unit has the at least one photodiode and can also have further photodiodes for detecting the infrared radiation and converting it into the measurement signal. Advantageously, the temperature sensor unit has a number of photodiodes which corresponds to a number of heating elements, in particular induction heating elements, of the heating unit. In an operating state of the temperature sensor unit, due to the internal photo effect the photodiode detects incident infrared radiation and converts this incident infrared radiation in at least one p-n junction and/or pin-junction into the measurement signal which flows at an output of the photodiode in the form of an electrical current, denoted hereinafter as the photocurrent. The measurement signal contains the at least one temperature parameter.

The amplifier unit has at least one amplifier for amplifying the measurement signal and can also have a plurality of amplifiers which, in particular, are substantially structurally the same. Preferably, a number of amplifiers of the amplifier unit corresponds to a number of photodiodes of the temperature sensor unit, wherein each amplifier is provided in each case for amplifying a measurement signal converted by a photodiode. However, it might also be conceivable that the amplifier unit has a smaller number of amplifiers relative to the number of photodiodes of the temperature sensor unit, wherein in this case at least one of the amplifiers is provided to amplify at least two different measurement signals from at least two different photodiodes, in particular chronologically offset to one another. The amplifier amplifies the input-side measurement signal, which is present in the form of the photocurrent at an input of the amplifier, into an output-side amplified measurement signal with a greater effective value relative to the input-side measurement signal. The amplifier could be configured as a current amplifier and could be provided to convert the measurement signal, which is present on the input-side in the form of the photocurrent, into an amplified measurement signal which is present on the output-side in the form of an electrical current with a greater effective value relative to the photocurrent. Preferably, the amplifier is configured as a current-controlled voltage source and is provided to convert the measurement signal, which is present on the input-side in the form of the photocurrent, into an output-side amplified measurement signal which is present in the form of an electrical voltage which is proportional to the photocurrent. The amplifier could have at least one transistor, in particular a bipolar transistor, and could be configured, in particular, as a transistor in which the base current thereof is the input-side measurement signal which is present in the form of the photocurrent and the collector current thereof is the output-side amplified measurement signal. Preferably, the amplifier is configured as an operational amplifier, in particular as a transimpedance amplifier. The amplifier has at least one input, via which the input-side measurement signal can be fed. Preferably, the amplifier has two inputs, and namely a negative input and a positive input. The photodiode is electrically conductively connected to at least one of the inputs of the amplifier, preferably via a shielded electrical cable. The amplifier has at least one, preferably exactly one, output at which the output-side amplified measurement signal can be tapped off. The amplifier could be configured as a non-inverting amplifier. Preferably, the amplifier is configured as an inverting amplifier, wherein one of the inputs is configured as an inverting input and one of the inputs is configured as a non-inverting input. Preferably, the amplifier is provided for a parallel voltage negative feedback operation. Preferably, the negative input is configured as the inverting input and the positive input is configured as the non-inverting input. Preferably, the photodiode is electrically conductively connected to the inverting input. Preferably, the amplifier has at least one feedback resistor. The feedback resistor is preferably electrically connected in parallel to the output and the inverting input. In parallel voltage negative feedback operation, at least one part of a voltage which drops at the output is returned via the feedback resistor to the inverting input. An amplification factor of the amplifier is characterized by the feedback resistor. In particular, the amplification factor, which is also denoted as the transimpedance, corresponds substantially to a value of the feedback resistor in an ideal direct current case, i.e. when the input-side measurement signal is a pure direct current. Depending on the desired amplification factor of the amplifier, the feedback resistor can have values of between 10 kΩ and 1 GΩ. Preferably, the feedback resistor has values of between 100 kΩ and 100 MΩ.

Preferably, the control unit is electrically conductively connected to the amplifier unit, in particular at least to the output of the amplifier. Preferably, the control unit is provided to tap off the output-side measurement signal at the output of the amplifier and to determine the temperature parameter from the measurement signal and namely, in particular, by means of at least one program which is provided therefor and which is able to be executed by the computing unit.

The compensation unit is provided for at least partially compensating for temperature influences on the conversion of the infrared radiation by the photodiode into the measurement signal and/or the amplification of the measurement signal by the amplifier of the amplifier unit. A temperature influence on the conversion of the infrared radiation by the photodiode into the measurement signal and/or the amplification of the measurement signal by the amplifier, in particular, can be characterized by an offset voltage, the real measurement signal which is present at the output of the amplifier deviating by the value thereof from an ideal measurement signal. As a result of the deviation between the real measurement signal and the ideal measurement signal, the temperature parameter which can be derived from the real measurement signal is also falsified relative to an actual temperature parameter which might be able to be derived from the ideal measurement signal. The offset voltage is made up of a first offset voltage component which is present at the input of the amplifier and a second offset voltage component which drops between the input and the output of the amplifier. The first offset voltage component is produced, in particular, by a dark current of the photodiode which is amplified together with the photocurrent. The dark current is exponentially dependent on a temperature of the photodiode and can change by up to three orders of magnitude over a temperature range of 100° C. The second offset voltage component is determined, in particular, by temperature-related changes of the parameters of the electrical and/or electronic components of the amplifier, for example temperature-related changes of electrical resistors, in particular temperature-related changes of the feedback resistor. Relative to the first offset voltage component, the second offset voltage component is negligibly small and produces errors of less than 1% over a temperature range of 100° C. Preferably, the compensation unit is provided for at least partially compensating for temperature influences on the conversion and/or amplification of the measurement signal by reducing and/or compensating for the offset voltage. In particular, the compensation unit is provided to reduce a value of the offset voltage at the output of the amplifier by at least 50%, advantageously at least 65%, particularly advantageously at least 80%, preferably by at least 95% and particularly preferably by at least 99%.

In the present document, numerical terms, such as for example “first” and “second”, which are positioned in front of specific terms merely serve to differentiate objects from one another and/or an assignment between objects and do not imply a total number and/or sequence of objects present. In particular, a “second object” does not necessarily imply the presence of a first object.

“Provided” is intended to be understood to mean specifically programmed, designed and/or equipped. An object being provided for a specific function is intended to be understood to mean that the object fulfills and/or executes this specific function in at least one use state and/or operating state.

The photodiode could be arranged in a low temperature region, for example in a region below the cooktop plate, which in an operating state has temperatures of a maximum of 125° C. The household appliance apparatus could have at least one radiation-conducting element which is permeable to infrared radiation and extends from an upper face to a lower face of the cooktop plate in order to conduct the infrared radiation from the upper face of the cooktop plate to the photodiode in the low temperature region. The radiation-conducting element could be configured, for example, as an optical fiber or as a transparent portion of the cooktop plate which is permeable to infrared radiation. In a particularly advantageous embodiment, however, it is proposed that the photodiode is arranged in a high temperature region having temperatures of up to 250° C. As a result, advantageously a cost-effective household appliance apparatus can be provided, in particular by a radiation-conducting element being able to be dispensed with. In addition, advantageously the production effort and/or assembly effort can be reduced. The high temperature region has temperatures of up to 250° C. in at least one operating state of the cooktop apparatus, in particular in an operating state of the heating unit. The high temperature region can comprise at least one partial region of the cooktop plate, in particular at least one partial region of a surface of the cooktop plate facing a user, in particular in a mounted state. The photodiode can be integrated, for example, inside the cooktop plate or arranged on the surface of the cooktop plate.

It is also proposed that the amplifier unit is arranged in a region in which the temperatures thereof are reduced relative to the temperatures in the high temperature region, in particular in at least one operating state. As a result, advantageously a measuring accuracy can be further improved. Preferably, in the operating state the temperatures of the region in which the amplifier unit is arranged are reduced relative to the temperatures in the high temperature region by at least 20%, advantageously by at least 30%, preferably by at least 40% and particularly preferably by at least 50%. Preferably, in the operating state the region in which the amplifier unit is arranged has a temperature of a maximum of 125° C. Moreover, it is proposed that the compensation unit is arranged in the region of the amplifier unit. As a result, advantageously a measuring accuracy can be further improved.

In a further advantageous embodiment, it is proposed that the temperature sensor unit and the amplifier unit are connected together via at least one, in particular shielded, electrical cable. Advantageously, a cost-effective household appliance apparatus can be provided by means of such an embodiment. Preferably, the electrical cable is configured as a shielded electrical cable. As a result, advantageously a measuring accuracy can be further improved, in particular by interference in the measurement signal, for example interference due to the electromagnetic fields generated by the heating unit in the operating state, being able to be reduced.

The compensation unit could be provided to compensate thermally for temperature influences on the conversion and/or amplification of the measurement signal, for example by means of active cooling of the amplifier unit and/or the temperature sensor unit. To this end, the compensation unit could have at least one cooling element, for example a fan and/or a heat exchanger, or the like. In a particularly advantageous embodiment, however, it is proposed that the compensation unit is provided to compensate electrically for temperature influences on the conversion and/or amplification of the measurement signal. As a result, advantageously a cost-effective household appliance apparatus can be provided. In addition, advantageously a measuring accuracy can be improved. The compensation unit could have, for example, an electrical measuring unit which is provided to measure the temperature influences, in the form of the offset voltage which is present during the conversion and/or amplification of the measurement signal, and an electrical error correction unit which comprises a digital-analog converter for converting the measured offset voltage into a digital signal, and a computing unit for correcting the measurement signal for the error caused by the offset voltage. Preferably, the compensation unit is provided to compensate in an electrically analog manner for temperature influences on the conversion and/or amplification of the measurement signal. The compensation unit is preferably provided to generate an analog electrical compensation signal, the value thereof corresponding at least substantially to a value of the offset voltage and having a sign opposite the offset voltage, in order to compensate in an electrically analog manner for temperature influences on the conversion and/or amplification. As a result, advantageously a compensation unit can be implemented for the electrical compensation of temperature influences on the conversion and/or amplification of the measurement signal by particularly simple technical means.

It is further proposed that the compensation unit and the amplifier unit are configured at least partially in one piece. As a result, advantageously a measuring accuracy can be further improved, in particular by short paths being implemented for transmitting signals between the compensation unit and the amplifier unit. The compensation unit and the amplifier unit, which are configured at least partially in one piece with one another, have at least one common component, for example a common electrical connecting line. Preferably, the compensation unit is part of the amplifier unit.

It is further proposed that the compensation unit has at least one further amplifier for compensating for temperature influences. Advantageously, by means of such an embodiment a compensation unit can be implemented by simple technical means. The further amplifier of the compensation unit is provided to compensate electrically for temperature influences on the conversion and/or amplification of the measurement signal. In particular, the further amplifier is provided to generate the analog electrical compensation signal, the value thereof corresponding at least substantially to a value of the offset voltage and having a sign opposite the offset voltage, in order to compensate in an electrically analog manner for temperature influences on the conversion and/or amplification.

It is further proposed that the amplifier and the further amplifier are at least substantially structurally the same. As a result, advantageously a measuring accuracy can be improved. Preferably, the amplifier and the further amplifier in each case are substantially structurally the same, such that their respective electrical and/or electronic components, for example electrical resistors and/or transistors and/or the like, are configured identically to one another with the exception of manufacturing-related deviations and/or tolerances, and in each case have approximately identical parameters and are connected together in each case in the same manner.

It is further proposed that the amplifier and the further amplifier are part of a common symmetrical electrical switching circuit. Advantageously, a measuring accuracy can be even further improved by means of such an embodiment. Preferably, the amplifier and the further amplifier form together with the photodiode the symmetrical electrical switching circuit. Preferably, a non-inverting input of the amplifier and a further non-inverting input of the further amplifier are connected together, an inverting input of the amplifier being connected to a first terminal of the photodiode and a further inverting input of the further amplifier being connected to a second terminal of the photodiode, such that the amplifier and the further amplifier are arranged symmetrically, in particular mirror-symmetrically to one another, relative to the photodiode.

The amplifier unit and the compensation unit could be arranged spaced apart from one another, in particular on different printed circuit boards. In an advantageous embodiment, however, it is proposed that the amplifier unit and the compensation unit are arranged on a common printed circuit board. As a result, advantageously a particularly compact household appliance apparatus can be provided. In addition, advantageously an influence of interference factors can be further reduced and thus a measuring accuracy can be further improved, in particular in which the amplifier of the amplifier unit and the further amplifier of the compensation unit have a temperature profile which is as uniform as possible.

The amplifier unit and/or the compensation unit could be configured as (an) integrated switching circuit(s). In an advantageous embodiment, however, it is proposed that the amplifier unit and the compensation unit are configured as discrete electrical switching circuits. As a result, advantageously the amplifier unit and the compensation unit can be implemented by simple technical means. In addition, advantageously a desired amplifier power and a desired compensation can be adapted in a particularly simple manner to different requirements, for example different types of photodiodes or different temperature conditions. In addition, advantageously a dependency on individual suppliers can be reduced, since specific integrated switching circuits can often be obtained only from a few suppliers, whereas single electrical and/or electronic components, such as resistors, transistors and/or the like, for producing the amplifier unit and the compensation unit can generally be obtained via a plurality of different suppliers and thus particularly inexpensively.

It is further proposed that the amplifier unit and the compensation unit in each case have a feedback capacitor. As a result, advantageously a measuring accuracy can be even further improved. Advantageously, a noise reduction can be achieved. Preferably, the amplifier unit has a feedback capacitor which is connected electrically in parallel to the feedback resistor of the amplifier. Preferably, the coupling unit has a further feedback capacitor which is connected electrically in parallel to a feedback resistor of the further amplifier. The feedback capacitors of the amplifier unit and the compensation unit are provided in each case to short-circuit the feedback resistors of the amplifier and the further amplifier for high-frequency AC signals and thus to reduce the bandwidth of the amplifier and the further amplifier. Preferably, the feedback capacitors of the amplifier unit and the compensation unit are configured substantially identically to one another, with the exception of manufacturing-related deviations, and have at least substantially identical electrical capacitances.

The invention further relates to a household appliance, in particular a cooktop, having a household appliance apparatus, as claimed in one of the above-described embodiments. Such a household appliance is characterized, in particular, by the advantageous properties which can be achieved by means of the household appliance apparatus regarding a measuring accuracy in temperature measurements.

The invention is further based on a method for operating a cooktop apparatus, in particular a cooktop apparatus, in particular according to one of the above-described embodiments, having at least one temperature sensor unit which has at least one photodiode provided for the purpose of detecting incident infrared radiation and converting it into a measurement signal, and having at least one amplifier unit which has at least one amplifier for amplifying the measurement signal.

It is proposed that temperature influences on the conversion and/or amplification of the measurement signal are at least partially compensated. Advantageously, a particularly reliable operation of the household appliance apparatus can be achieved by means of such a method. In particular, a high level of measuring accuracy can be achieved.

The household appliance apparatus is not intended to be limited herein to the above-described application and embodiment. In particular, for fulfilling a mode of operation described herein the household appliance apparatus can have a number of individual elements, components and units deviating from a number mentioned herein.

Further advantages are found in the following description of the drawing. Exemplary embodiments of the invention are shown in the drawing. The drawing, the description and the claims contain numerous features in combination. A person skilled in the art will also expediently consider the features individually and combine them to form further meaningful combinations.

In the drawing:

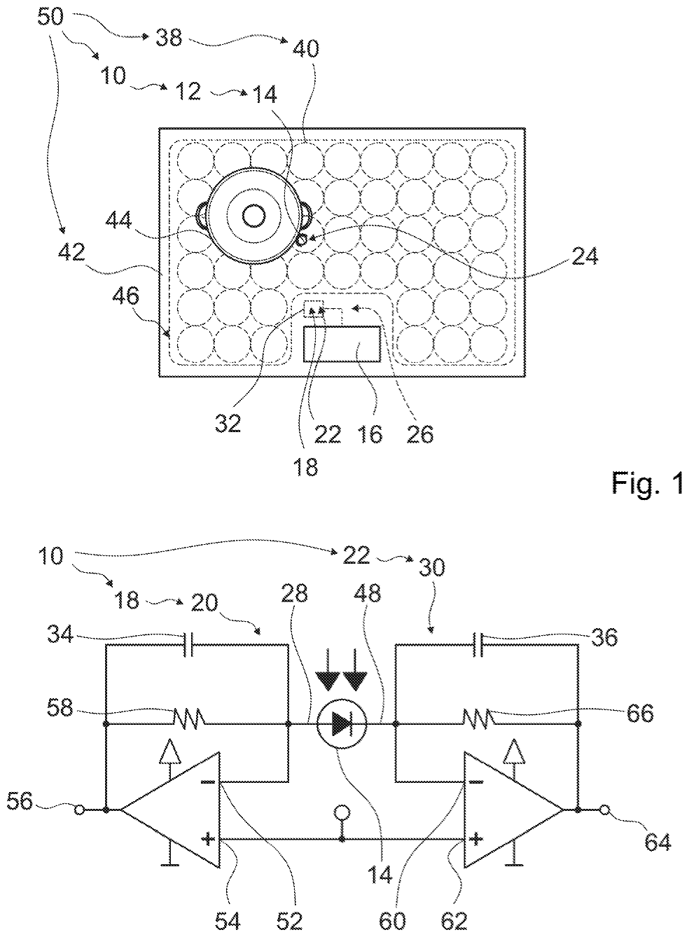

FIG. 1 shows a schematic plan view of a household appliance with a household appliance apparatus, comprising a temperature sensor unit, an amplifier unit and a compensation unit,

FIG. 2 shows a schematic electrical circuit diagram of the amplifier unit and the compensation unit,

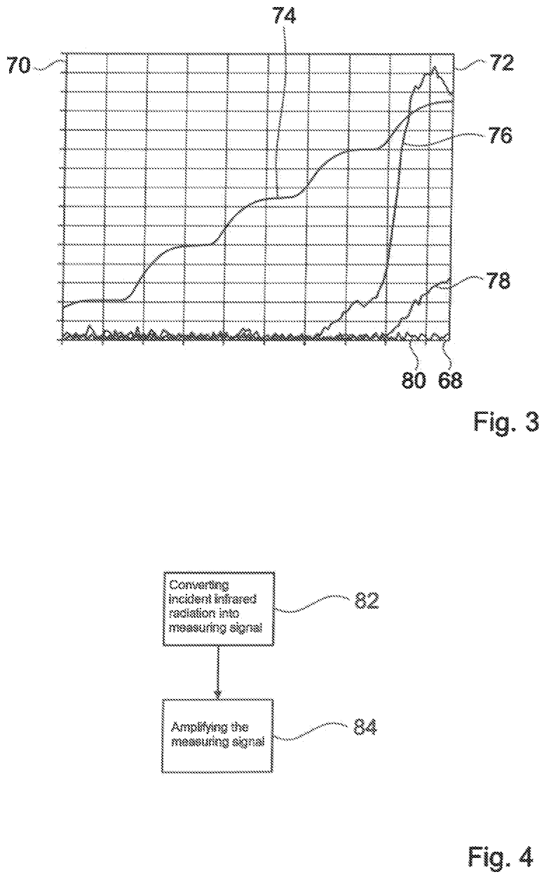

FIG. 3 shows a schematic diagram for illustrating temperature influences on the amplifier unit and the compensation unit and

FIG. 4 shows a schematic process flow diagram for illustrating a method for operating the household appliance apparatus.

FIG. 1 shows a household appliance 50 in a schematic plan view. The household appliance 50 is configured as a cooktop, and namely as an induction cooktop. The household appliance 50 comprises a heating unit 38 with a plurality of induction heating elements 40.

The household appliance 50 comprises a cooktop plate 42, for setting down an item of cookware, which is shown in FIG. 1 by way of example as a cooking pot 44, on a surface 46 of the cooktop plate 42. The cooktop plate 42 is arranged above the heating unit 38 in a mounted state. An item of cookware set down on the cooktop plate 42, for example the cooking pot 44, can be inductively heated by means of one or more of the induction heating elements 40 of the heating unit 38 of the household appliance 50. The cooktop plate 42 forms at least one high temperature region 24 having temperatures of up to 250° C. In an operating state, in which an item of cookware, for example the cooking pot 44, is set down on the set-down plate 42 and heated by means of the heating unit 38, a temperature of the surface 46 can be up to 250° C. in the high temperature region 24.

In the figures, in each case only one of the objects which is repeatedly present is provided with a reference sign.

The household appliance 50 has a household appliance apparatus 10. The household appliance apparatus 10 is configured as a cooktop apparatus and namely as an induction cooktop apparatus.

The household appliance apparatus 10 has at least one temperature sensor unit 12. The temperature sensor unit 12 is provided for the purpose of detecting incident infrared radiation (not shown) and converting it into a measurement signal (not shown). The household appliance apparatus 10 has a control unit 16 which is provided to determine at least one temperature parameter from the measurement signal. The temperature parameter characterizes a temperature of at least one item of cookware, for example the cooking pot 44, and/or the cooktop plate 42.

The temperature sensor unit 12 has at least one photodiode 14. The photodiode 14 is provided for the purpose of detecting incident infrared radiation and converting it into the measurement signal. In the present case, the photodiode 14 is integrated in the cooktop plate 42 and terminates flush with the surface 46 of the cooktop plate 42, and namely such that at least one cookware portion of an item of cookware, for example a pot base of the cooking pot 44, when set down on the cooktop plate 42, can be in contact with the photodiode 14 at least in some portions. The photodiode 14 is arranged in the high temperature region 24 which has temperatures of up to 250° C.

Alternatively, however, the photodiode 14 could be fully integrated in the cooktop plate 42 or arranged below the cooktop plate 42, wherein a region of the cooktop plate 42 above the photodiode 14 in these two cases, not shown here, would have to be configured to be at least partially transparent and permeable to infrared radiation, so that this can impinge on the photodiode 14.

The household appliance apparatus 10 has at least one amplifier unit 18. The amplifier unit 18 has at least one amplifier 20 (see FIG. 2) for amplifying the measurement signal. The amplifier unit 18 is arranged in a region 26 in which the temperatures thereof are reduced relative to the high temperature region 24. In the present case, a temperature in the region 26 is a maximum of 125° C. The region 26 is arranged below the cooktop plate 42 on an opposing side of the surface 46.

The temperature sensor unit 12 and the amplifier unit 18 are connected together via at least one electrical cable 28 (see FIG. 2). In the present case, the photodiode 14 and the amplifier 20 are connected together via the electrical cable 28. The electrical cable 28 is configured as a shielded cable, in order to reduce interference which could be produced in the operating state, in particular by the electromagnetic fields generated by the induction heating elements 40 for the inductive heating, on the transmission of the measurement signal from the photodiode 14 to the amplifier 20.

The household appliance apparatus 10 has a compensation unit 22. The compensation unit 22 is provided for at least partially compensating for temperature influences on the conversion and/or amplification of the measurement signal. In the present case, the compensation unit 22 is provided to compensate electrically for temperature influences on the conversion and/or amplification.

In the present case, the amplifier unit 18 and the compensation unit 22 are arranged on a common printed circuit board 32.

FIG. 2 shows a schematic electrical circuit diagram of the amplifier unit 18 and the compensation unit 22. The compensation unit 22 and the amplifier unit 18 are configured as discrete electrical switching circuits. The compensation unit 22 and the amplifier unit 18 are configured at least partially in one piece. In the present case, the compensation unit 22 is part of the amplifier unit 18.

The amplifier 20 of the amplifier unit 18 is configured as a transimpedance amplifier. The amplifier 18 has two inputs, and namely an inverting input 52 and a non-inverting input 54. The amplifier 18 has an output 56. The photodiode 14 is electrically conductively connected in the reverse direction to the inverting input 52 of the amplifier 20, and namely via the electrical cable 28. The amplifier 20 has a feedback resistor 58. The feedback resistor 58 is arranged electrically in parallel with the inverting input 52 and the output 56. The amplifier 20 has a feedback capacitor 34. The feedback capacitor 34 is arranged electrically in parallel with the feedback resistor 58. In the operating state, the feedback capacitor 34 represents a very low AC resistance for high-frequency electrical alternating currents and thus bridges the feedback resistor 58 so that high-frequency interference signals are not amplified by the amplifier 20.

The compensation unit 22 has at least one further amplifier 30 for at least partially compensating for temperature influences on the conversion and/or amplification of the measurement signal. The further amplifier 30 is configured as a transimpedance amplifier. The further amplifier 30 has two further inputs, and namely a further inverting input 60 and a further non-inverting input 62. The further amplifier 30 has a further output 64. The photodiode 14 is electrically conductively connected in the forward direction to the further inverting input 60 and namely by a shielded further electrical cable 48. The further amplifier 30 has a further feedback resistor 66. The further feedback resistor 66 is arranged electrically in parallel with the further inverting input 60 and the further output 64. The further amplifier 30 has a further feedback capacitor 36. The further feedback capacitor 36 is arranged electrically in parallel with the further feedback resistor 66. The non-inverting input 54 of the amplifier 20 and the further non-inverting input 62 of the further amplifier 30 are electrically conductively connected to one another.

The amplifier 20 and the further amplifier 30 are at least substantially structurally the same. In particular, the amplifier 20 and the further amplifier 30 have the same number of elements which in each case are substantially structurally the same. A corresponding element of the amplifier 30 exists for each element of the amplifier 20, wherein elements corresponding to one another in each case have substantially the same parameters, i.e. the same parameters with the exception of minimal manufacturing-related variations. For example, the feedback capacitor 34 of the amplifier 20 and the further feedback capacitor 36 of the further amplifier 30 in each case have at least substantially the same electrical capacitance. The amplifier 20 and the further amplifier 30 are part of a common symmetrical electrical switching circuit. In the present case, the amplifier 20 and the further amplifier 30 together with the photodiode 14 form the symmetrical electrical switching circuit and are arranged mirror-symmetrically to one another relative to the photodiode 14.

In the operating state of the household appliance apparatus 10, due to the internal photo effect the photodiode 14 converts incident infrared radiation into an input-side measurement signal in the form of a photocurrent. The photocurrent flows in the reverse direction to the inverting input 52 of the amplifier 20. The amplifier 20 in the operating state is operated in a parallel voltage negative feedback operation, wherein at least a part of the output voltage at the output 56 is returned via the feedback resistor 58 to the inverting input. An amplification factor of the amplifier 20 thus is characterized significantly by the value of the feedback resistor 58 and can be varied by a suitable choice of feedback resistor 58. An amplified output-side measurement signal, in the form of a voltage which is proportional to the photocurrent, can be tapped off between the output 56 of the amplifier 20 and the further output 64 of the further amplifier 30. The amplifier 20 can thus be regarded as a current-controlled voltage source.

In addition to the photocurrent, in the operating state the photodiode 14 generates a dark current, the value thereof increasing as the temperature rises. In an electrical equivalent circuit diagram (not shown) of the photodiode 14, the dark current and optionally further interference of the photodiode 14, for example a noise current, could be described by an equivalent resistor (not shown) which is connected in series to the photodiode 14. A voltage drop via this equivalent resistor is denoted as the input-side offset voltage. As the temperature rises, a value of the equivalent resistor falls and a value of the input-side offset voltage increases. The input-side offset voltage is present at the inverting input 52 and thus is amplified therewith. In order to compensate at least partially for this temperature influence on the measurement signal, which can be described by the input-side offset voltage, the compensation unit 22 has the further amplifier 30 which is operated in the operating state exactly as the amplifier 20 in the above-described parallel voltage negative feedback operation. The input-side offset voltage in the operating state is also present with the same value and a reverse sign at the further inverting input 60 and is amplified by the further amplifier 30. Since the photocurrent only flows in the reverse direction of the photodiode 14, it does not flow to the further inverting input 60. In the operating state, therefore, the further amplifier 30 only amplifies the input-side offset voltage but not the photocurrent. Since the amplifier 20 and the further amplifier 30 are at least substantially structurally the same, and as a result have at least substantially the same amplification factors, the input-side offset voltage is uniformly amplified by the amplifier 20 and the further amplifier 30. An electrically negatively amplified offset voltage is present at the output 56 of the amplifier 20 and an electrically positively amplified offset voltage is present at the further output 64 of the further amplifier 30, which mutually cancel one another out when the amplified output-side measurement signal between the two outputs 56, 64 is tapped off. The symmetrical amplifier circuit, shown in FIG. 2, consisting of the amplifier 20 and the further amplifier 30 thus has, at least in theory, an output-side offset voltage of zero for any temperatures. In addition to the above-described input-side offset voltage which is produced by the dark current of the photodiode 14, the elements of the amplifier 20 and the further amplifier 30, in particular the feedback resistor 58 and the further feedback resistor 66, also have a temperature dependence by which additional offset voltages are produced. Since a temperature profile of the region 26 is not completely uniform and the components of the amplifier 20 and the further amplifier 30 are not perfectly identical for production-related reasons, these additional offset voltages cannot be fully compensated by the compensation unit 22, however, as shown hereinafter in FIG. 3.

FIG. 3 shows a schematic diagram for illustrating temperature influences on the amplifier unit 18 and the compensation unit 22. A time is plotted in minutes on a horizonal scale 68. An offset voltage is plotted in volts on a left-hand vertical scale 70, wherein the left-hand vertical scale 70 ranges from 0 V to 0.015 V. An ambient temperature, in the region 26 in which the amplifier unit 18 and the compensation unit 22 are arranged, is plotted in degrees Celsius on a right-hand vertical scale 72, wherein a scale ranges from 0° C. to 150° C. A first curve 74 shows a path of the ambient temperature in the region 26. Over the time curve which is plotted on the horizontal scale 68 and which extends over a total of 7 hours, the ambient temperature rises in the region 26 from a starting value of ca. 20° C. to a maximum value of 125° C. A second curve 76 shows a first path of an offset voltage. For the measurement of the second curve 76, in each case a value of 1 GΩ has been selected for the feedback resistor 58 and the further feedback resistor 66. A third curve 78 shows a further path of an offset voltage, wherein for the measurement of the third curve 78 in each case a value of 100 MΩ has been selected for the feedback resistor 58 and the further feedback resistor 66. A fourth curve 80 shows a further path of an offset voltage at the output 56 of the amplifier 20, wherein for the measurement of the fourth curve 80 in each case a value of 10 MΩ has been selected for the feedback resistor 58 and the further feedback resistor 66. It has been shown that the measured offset voltages are very low for all three curves 76, 78, 80, which is due to the partial compensation of the temperature influences by the compensation unit. For ambient temperatures of the region 26 of up to 75° C., the offset voltage is barely measurable and is below 0.01 V. The path of the second curve 76 initially rises slightly from an ambient temperature of 75° C. and more sharply from an ambient temperature of 100° C., wherein the offset voltage does not exceed a value of 0.015 V. The path of the third curve 78 rises slightly from an ambient temperature of 100° C. and reaches maximum values of ca. 0.03 V. The path of the fourth curve 80 indicates very small offset voltages below 0.01 V over the entire temperature range of the ambient temperature in the region 26.

FIG. 4 shows a schematic process flow diagram of a method for operating the household appliance apparatus 10. In the method, temperature influences on the conversion and/or amplification of the measurement signal are at least partially compensated. The method comprises at least two method steps. In a first method step 82 of the method, incident infrared radiation is converted by means of the photodiode 14 into the input-side measurement signal in the form of the photocurrent. In a second method step 84, the input-side measurement signal is amplified by the amplifier 20, as described above relative to FIG. 2. Temperature influences which occur during the conversion of the infrared radiation into the photocurrent and/or the amplification and which can be described as offset voltages, in the second method step 84 are at least partially compensated by means of the further amplifier 30 of the compensation unit 22, and namely as described above with reference to FIG. 2.

### REFERENCE SIGNS

10 Household appliance apparatus
12 Temperature sensor unit
14 Photodiode
16 Control unit
18 Amplifier unit
20 Amplifier
22 Compensation unit
24 High temperature region
26 Region
28 Electrical cable
30 Further amplifier
32 Printed circuit board
34 Feedback capacitor
36 Further feedback capacitor
38 Heating unit
40 Induction heating element
42 Cooktop plate
44 Cooktop
46 Surface
48 Further electrical cable
50 Household appliance
52 Inverting input
54 Non-inverting input
56 Output
58 Feedback resistor
60 Further inverting input
62 Further non-inverting input
64 Further output
66 Further feedback resistor
68 Horizontal scale
70 Left-hand vertical scale
72 Right-hand vertical scale
74 First curve
76 Second curve
78 Third curve
80 Fourth curve
82 First method step
84 Second method step

1-15. (canceled)

16. A household appliance apparatus, in particular a cooktop apparatus, comprising:
a temperature sensor unit comprising a photodiode designed to detect incident infrared radiation and to convert the incident infrared radiation into a measurement signal;
an amplifier unit comprising an amplifier designed to amplify the measurement signal; and
a compensation unit designed to at least partially compensate for a temperature influence as the infrared radiation is converted into the measurement signal and/or the measurement signal is amplified.

17. The household appliance apparatus of claim 16, wherein the photodiode is arranged in a high temperature region having a temperature of up to 250° C.

18. The household appliance apparatus of claim 17, wherein the amplifier unit is arranged in a region in which a temperature thereof is reduced relative to a temperature in the high temperature region.

19. The household appliance apparatus of claim 18, wherein the compensation unit is arranged in the region of the amplifier unit.

20. The household appliance apparatus of claim 16, further comprising an electrical cable, the temperature sensor unit and the amplifier unit being connected together via the electrical cable.

21. The household appliance apparatus of claim 20, wherein the electrical cable is a shielded cable.

22. The household appliance apparatus of claim 16, wherein the compensation unit is designed to compensate electrically for a temperature influence as the infrared radiation is converted into the measurement signal and/or the measurement signal is amplified.

23. The household appliance apparatus of claim 16, wherein the compensation unit and the amplifier unit are configured at least partially in one piece.

24. The household appliance apparatus of claim 16, wherein the compensation unit comprises an amplifier designed to compensate for the temperature influence.

25. The household appliance apparatus of claim 24, wherein the amplifier of the amplifier unit and the amplifier of the compensation unit are at least substantially structurally identical.

26. The household appliance apparatus of claim 24, wherein the amplifier of the amplifier unit and the amplifier of the compensation unit are part of a common symmetrical electrical switching circuit.

27. The household appliance apparatus of claim 16, further comprising a printed circuit board, the amplifier unit and the compensation unit being commonly arranged on the printed circuit board.

28. The household appliance apparatus of claim 16, wherein the amplifier unit and the compensation unit are configured as discrete electrical switching circuits.

29. The household appliance apparatus of claim 16, wherein the amplifier unit and the compensation unit each comprise a feedback capacitor.

30. A household appliance, in particular a cooktop, the household appliance comprising a household appliance apparatus which includes a temperature sensor unit comprising a photodiode designed to detect incident infrared radiation and to convert the incident infrared radiation into a measurement signal, an amplifier unit comprising an amplifier designed to amplify the measurement signal, and a compensation unit designed to at least partially compensate for a temperature influence as the infrared radiation is converted into the measurement signal and/or the measurement signal is amplified.

31. A method for operating a household appliance apparatus, in particular a cooktop apparatus, the method comprising:
detecting incident infrared radiation and converting the incident infrared radiation into a measurement signal by a photodiode of a temperature sensor unit;
amplifying the measurement signal with an amplifier of an amplifier unit; and
at least partially compensating with a compensation unit a temperature influence as the infrared radiation is converted into the measurement signal and/or the measurement signal is amplified.

32. The method of claim 31, further comprising arranging the amplifier unit in a region in which a temperature thereof is reduced relative to a temperature in a temperature region of the photodiode of up to 250° C.

33. The method of claim 31, wherein the temperature influence is electrically compensated as the infrared radiation is converted into a measurement signal and/or the measurement signal is amplified.

34. The method of claim 31, further comprising compensating for the temperature influence with an amplifier of the compensation unit.

35. The method of claim 34, further comprising forming the amplifier of the amplifier unit and the amplifier of the compensation unit as parts of a common symmetrical electrical switching circuit.
